(19) United States
(12) Patent Application Publication
(10) Pub. No.: US 2011/0242435 A1
(43) Pub. Date: Oct. 6, 2011

(54) ILLUMINATION DEVICE, DISPLAY DEVICE, AND TELEVISION RECEIVER

(75) Inventor: Hirokazu Mouri, Osaka-shi (JP)

(73) Assignee: SHARP KABUSHIKI KAISHA, Osaka-shi, Osaka (JP)

(21) Appl. No.: 13/139,519

(22) PCT Filed: Sep. 10, 2009
(86) PCT No.: PCT/JP2009/065822

§ 371 Date: Jun. 14, 2011

(30) Foreign Application Priority Data
Dec. 18, 2008 (JP) 2008-322052

(51) Int. Cl. H04N 5/66; F21V 11/00; G02F 1/13357; G02F 1/1335

(52) U.S. Cl. 348/739; 362/235; 362/97.1; 349/61; 348/E05.133

(57) ABSTRACT

An illumination device includes a chassis 22 on which lamps 21 are arranged on the front side, an optical member 24 arranged in a position opposed to the chassis 22 across the lamps 21, lamp clips 30 that have protruding pins 34 protruding toward the optical member 24 and are attached to the chassis 22 to retain the lamps 21, and cushions 40 arranged between the lamp clips 30 and the chassis 22. According to such a configuration, the vibration of the lamp clips 30 is absorbed by the cushions 40. Therefore, since it is possible to suppress a creak compared with the case in which the lamp clips 30 and the chassis 22 directly rub against each other, it is possible to prevent the deterioration in quality.

### TECHNICAL FIELD

The present invention relates to an illumination device, a display device, and a television receiver.

### BACKGROUND ART

A display device with a non-self-luminous display panel such as a display device of a liquid crystal television includes, in general, a backlight unit as a device for illumination. The backlight unit includes a chassis and a large number of fluorescent tubes arranged on the front side (the display panel side) of the chassis. The fluorescent tubes are retained by lamp clips attached to the chassis (e.g., Patent Document 1). In a position further on the display panel side than the fluorescent tubes in the chassis, a diffusing plate for uniformly diffusing light of the fluorescent tubes is provided. Protruding pins protruding toward the diffusing plate side are provided in the lamp clips. The protruding pins support the diffusing plate from the fluorescent tubes side, whereby a bend or a warp of the diffusing plate to the fluorescent tubes side is restricted.
[Patent Document 1] Japanese Patent Application Laid-Open Publication No. 2008-288047

### PROBLEMS TO BE SOLVED BY THE INVENTION

In the backlight unit, since a temperature environment changes because of turn-on and turn-off of the fluorescent tubes, the diffusing plate thermally expands or contracts depending on the change of the temperature environment. Then, the vibration of the diffusing plate is transmitted to the protruding pins of the lamp clips that support the diffusing plate. It is likely that the lamp clips and the chassis rub against each other because of the propagated vibration and a creak occurs. There is a need for measures against such a creak because the creak deteriorates the quality of a product.

### DISCLOSURE OF THE INVENTION

The present invention has been completed on the basis of the circumstances explained above and it is an object of the present invention to provide an illumination device, a display device, and a television receiver that can prevent the deterioration in quality.

### MEANS FOR SOLVING THE PROBLEMS

An illumination device of the present invention includes lamps, a chassis in which the lamps are arranged, an optical member arranged in a position opposed to the chassis across the lamps, lamp clips that are attached to the chassis, retain the lamps, and have protruding pins protruding toward the optical member, and cushions arranged between the lamp clips and the chassis.

According to such a configuration, the vibration of the lamp clips is absorbed by the cushions. Therefore, since it is possible to suppress a creak compared with the case in which the lamp clips and the chassis directly rub against each other, it is possible to prevent the deterioration in quality.

### BRIEF DESCRIPTION OF THE DRAWINGS

FIG. 1 is a disassembled perspective view showing the schematic configuration of a television receiver according to a first embodiment;

FIG. 2 is a disassembled perspective view showing the schematic configuration of a liquid crystal display device;

FIG. 3 is a partial enlarged sectional view of the liquid crystal display device;

FIG. 4 is a partial enlarged sectional view showing a state before lamp clips are attached to a chassis;

FIG. 5 is a rear view of the lamp clip;

FIG. 6 is a partial enlarged sectional view of a liquid crystal display device according to a second embodiment;

FIG. 7 is a rear view of a lamp clip;

FIG. 8 is a partial enlarged sectional view of a liquid crystal display device according to a third embodiment; and

FIG. 9 is a rear view of a lamp clip.

### BEST MODE FOR CARRYING OUT THE INVENTION

### First Embodiment

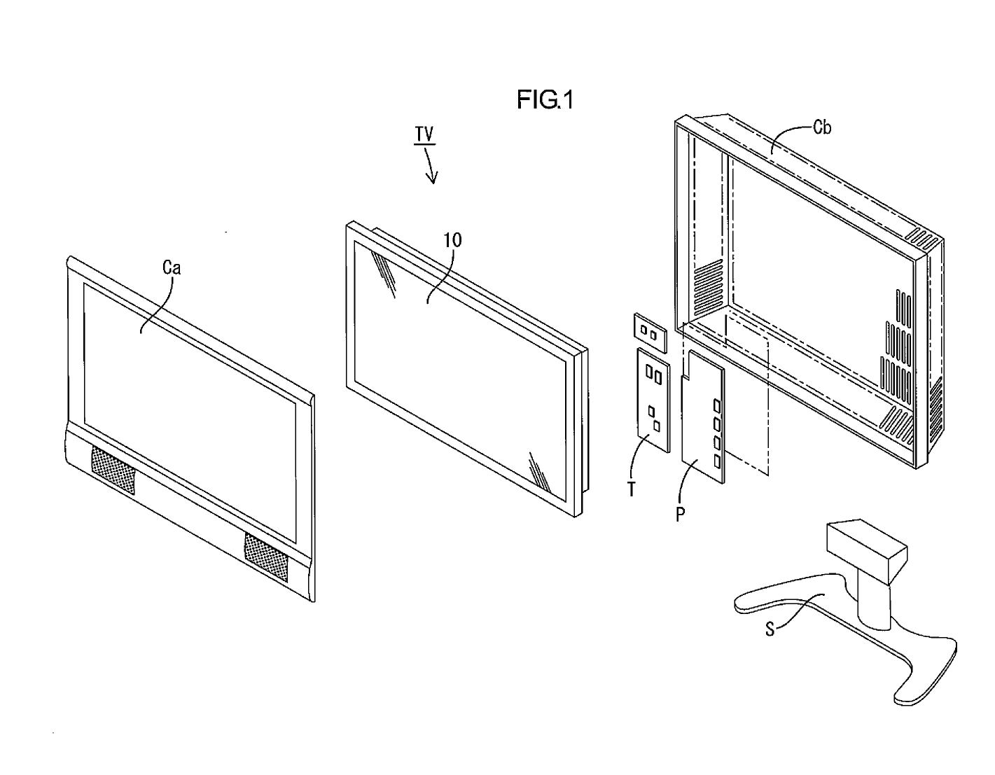

A first embodiment embodying the present invention is explained in detail below with reference to FIGS. 1 to 5.

In this embodiment, a television receiver TV including a liquid crystal display device 10 (a display device) is illustrated. The television receiver TV includes, as shown in FIG. 1, the liquid crystal display device 10, cabinets Ca and Cb that house the liquid crystal display device 10 to hold the liquid crystal display device 10 from the front and the back, a power source P, a tuner T for receiving a television broadcast and the like, and a stand S. The liquid crystal display device 10 is housed in the cabinets Ca and Cb in a vertically-placed posture in which a display surface is faced in a substantially vertical direction. In the following explanation, for each of the component members, the lower left side of FIG. 1 (the front side and the display side of the television receiver TV) is assumed to be front, the upper right side is assumed to be back, the upper side is assumed to be above, and the lower side is assumed to be below.

The liquid crystal display device 10 includes a liquid crystal panel 11 (corresponding to the display panel of the present invention) that assumes a horizontal rectangular shape as a whole when viewed from the front-back direction and is capable of displaying an image and a backlight unit 20 (corresponding to the illumination device of the present invention) as an external light source that radiates light toward the liquid crystal panel 11. The liquid crystal panel 11 and the backlight unit 20 are integrally retained by a retaining member such as a bezel 12.

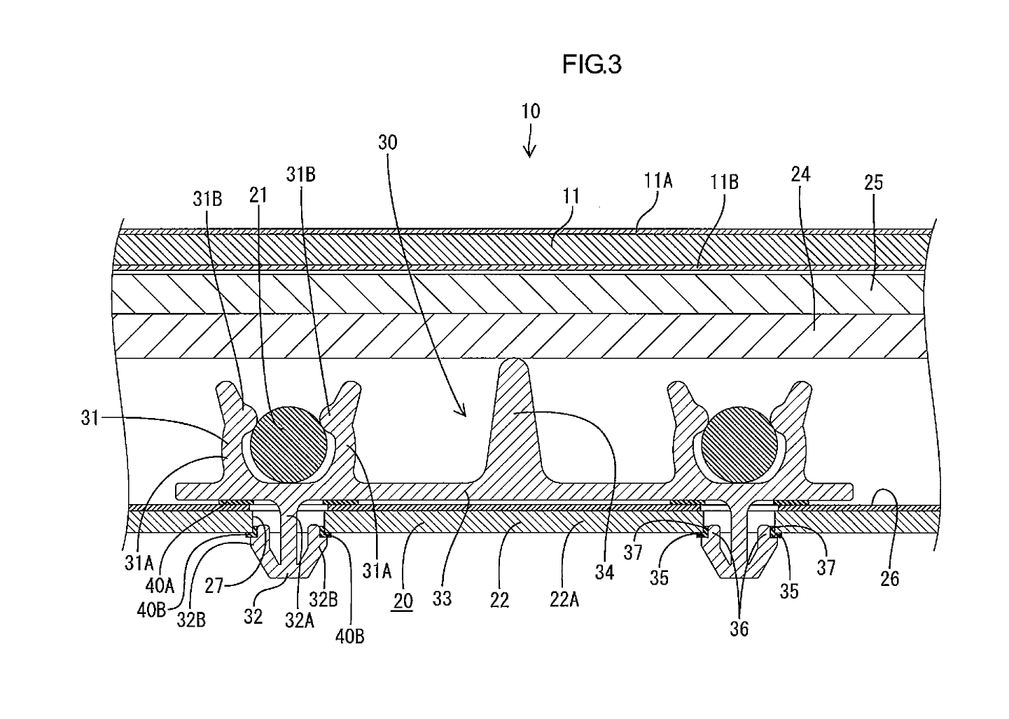

The liquid crystal panel 11 includes a pair of transparent substrates of glass (having translucency) that assume a horizontal rectangular shape and a liquid crystal layer (not shown) that is arranged between both the substrates and has an optical characteristic that changes according to applied voltage. Polarizing plates 11A and 11B are adhered to the front surface and the rear surface of the liquid crystal panel 11 (see FIG. 3).

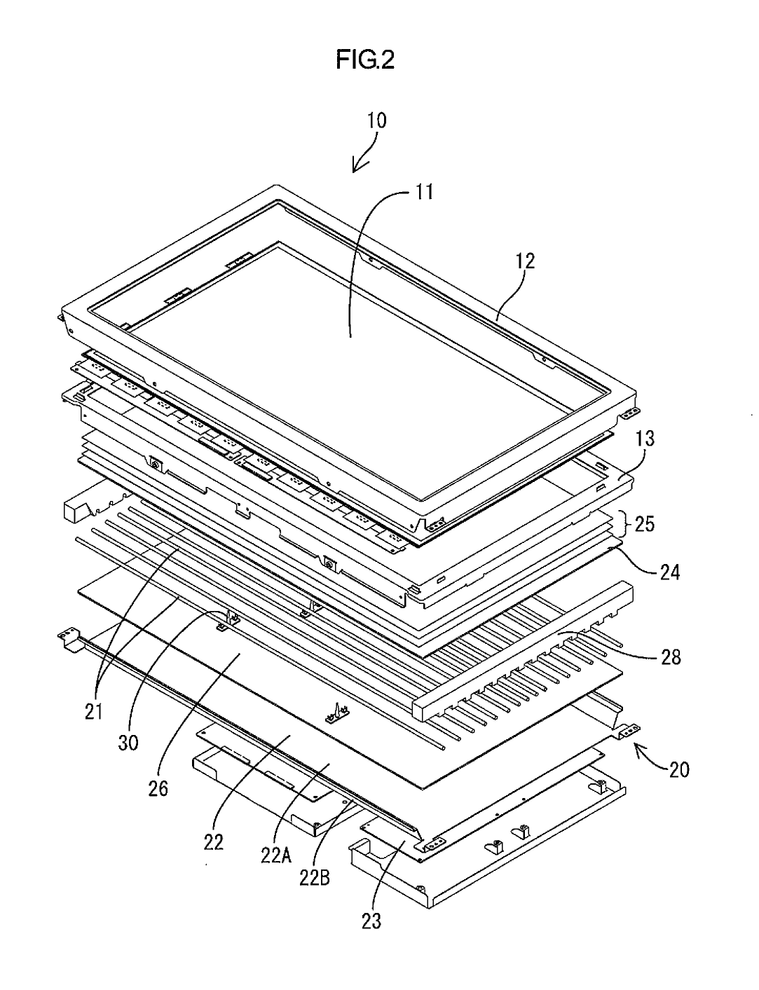

As shown in FIG. 2, the liquid crystal panel 11 is fixed with the peripheral margin portion held between the bezel 12 disposed on the front side and a frame 13 disposed on the rear side. The bezel 12 and the frame 13 are made of metal (e.g., aluminum) and assume a horizontal-rectangular frame shape along the peripheral margin portion of the liquid crystal panel 11 (surrounding a display area of the liquid crystal panel 11).

The backlight unit 20 is a so-called direct type backlight unit 20 and is provided right under the rear surface of the liquid crystal panel 11.

The backlight unit 20 includes a chassis 22 having discharge tubes 21 (corresponding to the lamps of the present invention) arranged on the front side. The chassis 22 is made of metal and includes a bottom plate 22A assuming a flat plate shape and side plates 22B standing from the peripheral margin of the bottom plate 22A to the front side. The chassis 22 as a whole assumes a shallow pan shape opening to the front side. In plan view, the bottom plate 22A assumes a horizontal rectangular shape larger than the liquid crystal panel 11. The chassis 22, the bezel 12, and the frame 13 are fixed to one another by not shown screws. An inverter substrate 23 that controls driving of the discharge tubes 21 is attached to the rear surface of the chassis 22.

A diffusing plate 24 (corresponding to the optical member of the present invention) is disposed in an opening of the chassis 22 (a position opposed to the chassis 22 across the discharge tubes 21). In the diffusing plate 24, light scattering particles are dispersed and mixed in a tabular member made of synthetic resin. The diffusing plate 24 has a function of diffusing light of the discharge tubes 21 serving as linear light sources.

An optical sheet 25 is provided on the front side of the diffusing plate 24. The optical sheet 25 is formed by laminating plural sheets having different functions. For example, the sheets are a diffusing sheet, a lens sheet, and a reflection-type polarizing plate. The optical sheet 25 has a function of changing light emitted from the discharge tubes 21 and transmitted through the diffusing plate 24 to planar light.

Both the diffusing plate 24 and the optical sheet 25 assume a horizontal rectangular shape. The peripheral margin portions of the diffusing plate 24 and the optical sheet 25 are held between the frame 13 and the side plates 22B of the chassis 22 or holders 28 explained later.

A reflection sheet 26 that reflects the light from the discharge tubes 21 to the front side (the diffusing plate 24 side) is laid on the surface of the bottom plate 22A of the chassis 22. The reflection sheet 26 is made of synthetic resin. The surface of the reflection sheet 26 is colored white, which has a good reflectivity. The reflection sheet 26 assumes a horizontal rectangular shape that covers substantially the entire area of the surface (the inner surface) of the bottom plate 22A of the chassis 22 along the surface.

Insertion holes 27, into which locking portions 32 of lamp clips 30 explained later are inserted, are provided in the bottom plate 22A of the chassis 22 and the reflection sheet 26. The insertion holes 27 are formed in attaching positions of the lamp clips 30 in the bottom plate 22A of the chassis 22 and the reflection sheet 26. Each of the insertion holes 27 assumes a rectangular shape and pierces through the reflection sheet 26 and the bottom plate 22A in the front-back direction.

Plural discharge tubes 21 (in this embodiment, cold cathode tubes) that radiate light toward the liquid crystal panel 11 are housed on the inside (a portion surrounded by the bottom plate 22A and the side plates 22B) of the chassis 22. The discharge tubes 21 assume an elongated tube shape and are arranged at a fixed space from one another in a direction in which axes of the discharge tubes 21 coincide with the long side direction of the chassis 22. Opposite ends (non-light emitting portions in which electrodes are provided) of the discharge tubes 21 are covered with the holders 28. The middle portions of the discharge tubes 21 are retained by the lamp clips 30 explained later. The holders 28 are made of synthetic resin that appears white, which has a good reflectivity of light, and assume an elongated general box shape along edges extending in the short side direction among the peripheral margins of the chassis 22.

The backlight unit 20 includes plural lamp clips 30 that retain the discharge tubes 21. The lamp clips 30 are made of synthetic resin (e.g., polycarbonate). The surfaces of the lamp clips are colored white, which has a good reflectivity of light. Each of the lamp clips 30 includes lamp gripping portions 31 that grip the discharge tubes 21, the locking portions 32 that are inserted into the insertion holes 27 and locked to the chassis 22 from the back (the front in the inserting direction), and the base part 33 that holds the chassis 22 and the reflection sheet 26 between the base part 33 and the locking portions 32 (see FIG. 3).

The base part 33 assumes an elongated substantially rectangular plate shape. A protruding pin 34 protruding toward the diffusing plate 24 is provided in the center position (center in both the long side and short side directions) of the base part 33. The protruding pin 34 assumes a substantially conical shape having a radial dimension gradually decreasing toward the protruding end. A protrusion dimension of the protruding pin 34 is set larger than a protrusion dimension of the lamp gripping portions 31. Since this protruding pin 34 supports the diffusing plate 24 from the rear side, a bend or a warp of the diffusing plate 24 to the rear side (the discharge tube 21 side) is restricted.

A pair of lamp gripping portions 31 are provided at opposite ends in the long side direction of the base part 33. A space between the pair of lamp gripping portions 31 coincides with a parallel arrangement pitch of the discharge tubes 21. Each of the lamp gripping portions 31 includes a pair of arm portions 31A that hold the discharge tube 21. The lamp gripping portion 31 as a whole assumes a substantially annular shape opening to the front side. The pair of arm sections 31A stand from the base part 33 to the front side in a cantilever shape and is formed elastically deformable in a direction in which the pair of arm portions 31A approach and separate from each other. The lamp gripping portion 31 is provided in a direction in which an opposing direction of the pair of arm portions 31A coincides with the long side direction of the base part 33. The arm portions 31A are curved in a substantially arcuate shape.

A pair of retaining protrusions 31B protruding inward are provided in positions closer to the distal ends of the pair of arm portions 31A. The pair of retaining protrusions 31B are set in contact with substantially a half on the front side of the discharge tube 21 gripped by the lamp gripping portion 31.

A pair of locking portions 32 are provided on the rear surface of the base part 33 at opposite ends in the long side direction of the base part 33 (positions right behind the pair of lamp gripping portions 31). Each of the locking portions 32 includes a base portion 32A protruding from the base part 33 to the rear side and a pair of locking legs 32B folded back from the distal end of the base portion 32A to the base part 33 side and arranged to be opposed to the sides of the base portion 32A.

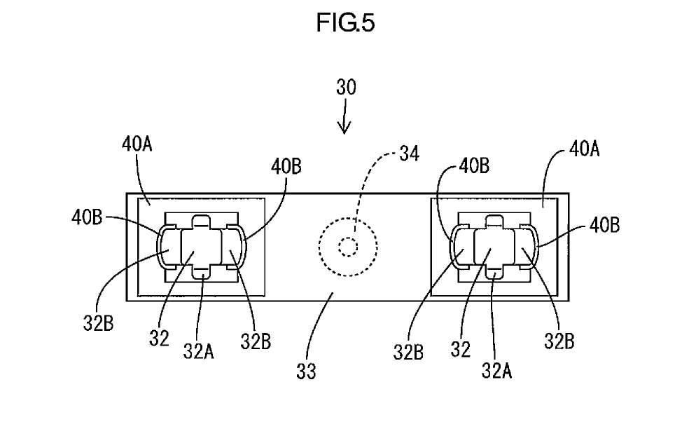

The base portion 32A assumes a square pillar shape protruding substantially perpendicularly from the rear surface of the base part 33. The sectional shape of the base portion 32A assumes a substantially rectangular shape long in the short side direction of the base part 33 (see FIG. 5). An axial direction dimension (a front-back direction dimension) of the base portion 32A is larger than a dimension obtained by adding up the thickness dimension of the chassis 22 and the thickness dimension of the reflection sheet 26. The axial direction dimension is a dimension at which a substantially half of the base portion 32A protrudes to the rear side of the chassis 22 in a state in which the lamp clip 30 is attached to the chassis 22 (see FIG. 3). The base portion 32A is located in the center in the opposing direction of the pair of arm portions 31A of the lamp gripping portion 31.

The pair of locking legs 32B extend to the front side from the protruding end (the rear side end) of the base portion 32A in a cantilever shape. The locking legs 32B assumes an oblique posture in which the locking legs 32B gradually separate from the base portion 32A from coupling ends with the base portion 32A toward a free end side. The locking legs 32B are formed elastically deformable, with the coupling ends set as a fulcrum, in a direction in which the locking legs 32B approach and separate from the base portion 32A. The width dimension (the width dimension in a direction along the short side direction of the base part 33) of the locking legs 32B is slightly smaller than the width direction in the same direction of the base portion 32A and is substantially fixed from the coupling ends to the free ends (see FIG. 5).

Locking surfaces 35 locked to the rear surface of the chassis 22 are formed at the distal ends (the free ends) of the locking legs 32B. The locking surfaces 35 are substantially parallel to the rear surface of the base part 33. A dimension slightly larger than the dimension obtained by adding up the thickness dimension of the chassis 22 and the thickness dimension of the reflection sheet 26 is provided between the locking surfaces 35 and the base part 33 in a natural state of the locking legs 32B.

Entering portions 36 that enter the inside of the insertion holes 27 are provided at the distal ends of the locking legs 32B. The entering portions 36 protrude further to the front side than the locking surfaces 35. Surfaces on the locking surfaces 35 side (on the opposite side of the base portion 32A) of the entering portions 36 are entering surfaces 37 standing substantially perpendicularly from the locking surfaces 35. In a state in which the lamp clip 30 is attached to the chassis 22, the entering surfaces 37 are arranged to be opposed to the circumference surfaces of the insertion holes 27.

All the lamp clips 30 are attached to be dispersed in the middle portion in the long side direction of the chassis 22 in a direction in which the long side direction of the base parts 33 coincides with the parallel arrangement direction of the discharge tubes 21 (substantially orthogonal to the axial direction of the discharge tubes 21).

Cushions 40 are arranged between the lamp clip 30 and the chassis 22 (the reflection sheet 26). The cushions 40 are made of black resin (in this embodiment, polyurethane) having thermal conductivity lower than that of the lamp clip 30. The surfaces of the cushions 40 assume a black color.

The cushions 40 assume a sheet shape and include first cushions 40A arranged between the base part 33 and the chassis 22 and second cushions 40B arranged between the locking portions 32 and the chassis 22. The thickness dimension of the cushions 40 is substantially fixed over the entire cushions 40. The first cushions 40A and the second cushions 40B are provided in each of the locking portions 32 and bonded to the lamp clip 30 by a not-shown adhesive. The first cushions 40A and the second cushions 40B are separated.

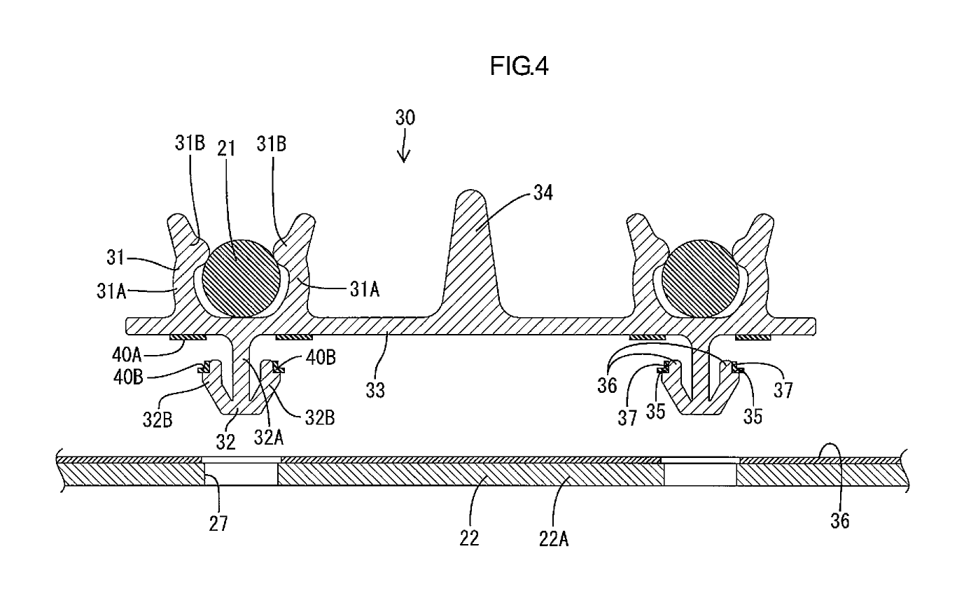

The first cushions 40A are bonded to the rear surface of the base part 33. The first cushions 40A assume a substantially rectangular frame shape surrounding the entire circumference of the insertion holes 27. The first cushions 40A are adhered to positions of the rear surface of the base part 33 surrounding the base portions 32A of the locking portions 32. The base portions 32A are respectively located substantially in the centers of the first cushions 40A (see FIG. 5). Portions of the first cushions 40A opposed to the long side direction of the base part 33 are respectively located on the rear sides of the arm portions 31A of the lamp gripping portions 31 (see FIG. 4).

The second cushions 40B are respectively bonded to the entering surfaces 37 and the locking surfaces 35 of the distal ends of the pair of locking legs 32B. The second cushions 40B assume a shape bent in an L shape in section along the entire surfaces of the entering surfaces 37 and the locking surfaces 35.

Attachment of the lamp clip 30 is explained below.

The protruding pins 34 of each of the lamp clips 30 are pinched by finger tips, the pair of locking portions 32 are positioned to be respectively opposed to the insertion holes 27, and the lamp clips 30 are brought close to the chassis 22 side. Then, the pair of locking legs 32B of the locking portions 32 come into contact with hole edges of the insertion holes 27 and are elastically deformed in a direction approaching the base portions 32A. The locking portions 32 are inserted into the insertion holes 27. Simultaneously with the locking surfaces 35 of the locking portions 32 reaching the rear side of the chassis 22, the locking legs 32B elastically return, the locking surfaces 35 are locked to the rear surface of the chassis 22, and the entering surfaces 37 of the entering portions 36 approach the circumferential surfaces of the insertion holes 27. At this point, portions of the second cushions 40B adhered to the locking surfaces 35 are held between the rear surface of the chassis 22 (the rear surfaces of the hole edges of the insertion holes 27) and the locking surfaces 35 and are in contact with the chassis 22. Portions adhered to the entering surfaces 37 are held between the circumferential surfaces of the insertion holes 27 and the entering surfaces 37 and are in contact with the chassis 22. The first cushions 40A are held between the base part 33 and the bottom plate 22A of the chassis 22 (the reflection sheet 26) and are in contact with the chassis 22. In this way, the lamp clip 30 is attached to the chassis 22 in a state in which the first cushions 40A and the second cushions 40B are arranged between the lamp clip 30 and the chassis 22.

Actions and effects of the first embodiment configured as explained above are explained below.

When the temperature environment of the backlight unit 20 changes because of turn-on and turn-off or the like of the discharge tubes 21 and the diffusing plate 24 thermally expands or thermally contracts, vibration is transmitted to the protruding pins 34 of the lamp clips 30 that support the diffusing plate 24. At this point, since the backlight unit 20 in this embodiment includes the cushions 40 arranged between the lamp clips 30 and the chassis 22, the vibration of the lamp clips 30 is absorbed by the cushions 40. Therefore, since it is possible to suppress the lamp clips 30 and the chassis 22 from directly rubbing against each other to cause a creak, it is possible to prevent deterioration in quality.

The cushions 40 are made of a resin material having thermal conductivity lower than that of the lamp clips 30. Consequently, the heat of the discharge tubes 21 less easily escapes from the lamp clips 30 to the chassis 22 through the cushions 40. If the heat of the discharge tubes 21 is transmitted from the lamp clips 30 to the chassis 22 via the cushions and discharged, it is likely that portions of the discharge tubes 21 retained by the lamp clips 30 have lower temperature than the other portions, the luminance of the portions falls, and unevenness occurs. However, since the heat of the discharge tubes 21 less easily escapes to the chassis 22 through the cushions 40, it is possible to prevent such unevenness from occurring.

The cushions 40 assume a black color. Consequently, since the cushions 40 absorb light, it is possible to prevent the light of the discharge tubes 21 from easily leaking from the insertion holes 27.

### Second Embodiment

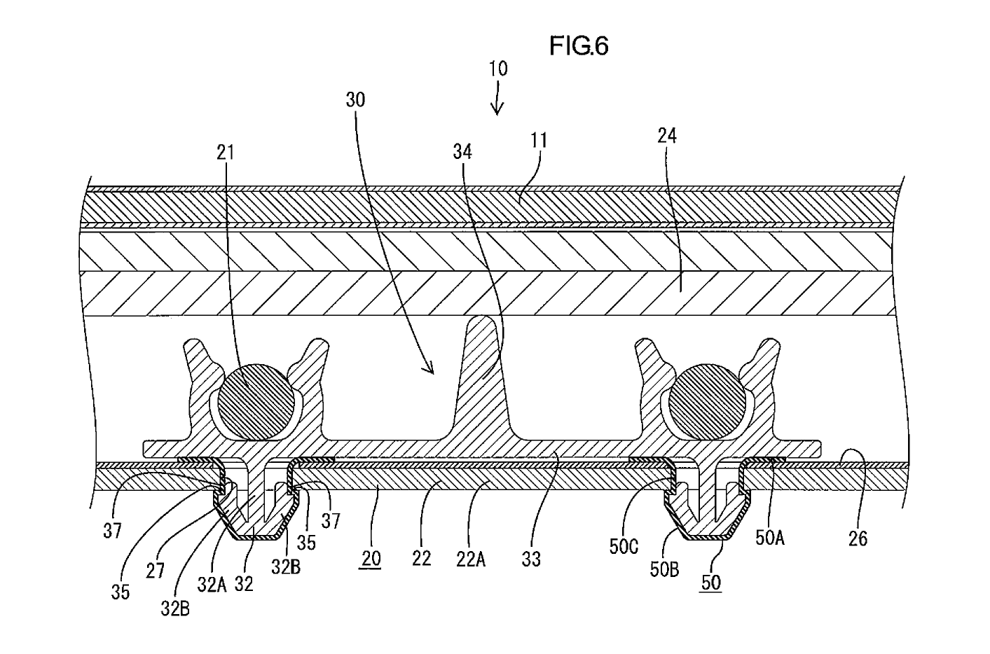

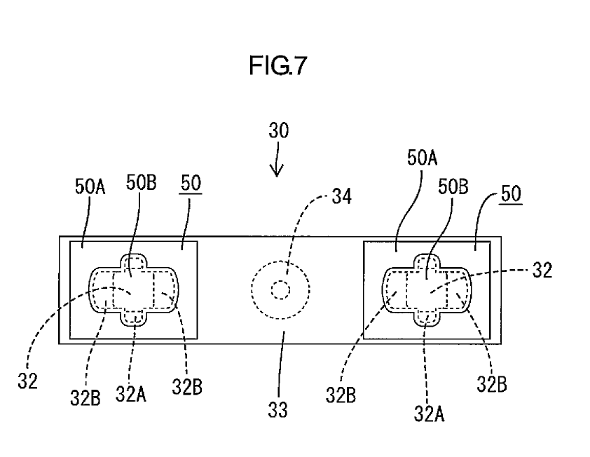

A television receiver TV according to a second embodiment embodying the present invention is explained below with reference to FIGS. 6 and 7.

The television receiver TV according to this embodiment is different from the first embodiment in that cushions 50 integrally include portions arranged between the base part 33 and the chassis 22 and portions arranged between the locking portions 32 and the chassis 22. Components same as those in the first embodiment are denoted by the same reference numerals and signs and redundant explanation of the components is omitted.

The television receiver TV according to this embodiment includes the liquid crystal display device 10 including, as in the first embodiment, the backlight unit 20 and the liquid crystal panel 11 that uses light from this backlight unit 20 for display.

As in the first embodiment, the backlight unit 20 includes the chassis 22 having the discharge tubes 21 arranged on the front side, the diffusing plate 24 arranged in a position opposed to the chassis 22 across the discharge tubes 21, and the lamp clip 30 that has the protruding pin 34 protruding toward the diffusing plate 24 and is attached to the chassis 22 to retain the discharge tubes 21.

As in the first embodiment, the cushions 50 are arranged between the lamp clip 30 and the chassis 22 (the reflection sheet 26). As in the first embodiment, the cushions 50 have thermal conductivity lower than that of the lamp clip 30 and the surfaces of the cushions 50 assume a black color.

The cushions 50 assume a sheet shape integrally including the portions arranged between the base part 33 and the chassis 22 and the portions arranged between the locking portions 32 and the chassis 22. The cushions 50 are provided in each of the locking portions 32 and bonded to the lamp clip 30 by a not-shown adhesive.

The cushions 50 assume a form that continuously covers the outer surfaces of the locking portions 32 to portions of the rear surface of the base part 33 around the locking portions 32. Portions of the cushions 50 along the rear surface of the base part 33 are referred to as first cushioning portions 50A and portions along the outer surfaces of the locking portions 32 are referred to as second cushioning portions 50B.

The external shape of the first cushioning portions 50A assume a substantial rectangular shape larger than the insertion holes 27. The first cushioning portions 50A are adhered to cover projected portions of the lamp gripping portions 31 on the base part 33.

The second cushioning portions 50B are provided in substantially the centers of the first cushioning portions 50A. The second cushioning portions 50B are adhered to the outer surfaces of the locking portions 32 (the entire surfaces excluding opposed surfaces of the pair of locking legs 32B and the base portions 32A). Specifically, the second cushioning portions 50B are adhered to surfaces on the opposite side of the entering surfaces 37 of the pair of locking legs 32B, the locking surfaces 35, and the base portions 32A (contact surfaces with the hole edges of the insertion holes 27 during attachment work) and both side surfaces of the locking legs 32B and the base portions 32A (side surfaces substantially orthogonal to opposed surfaces of the locking legs 32B and the base portions 32A).

Portions between the first cushioning portions 50A and the second cushioning portions 50B are third cushioning portions 50C arranged along the circumferential surfaces of the insertion holes 27. The third cushioning portions 50C are substantially perpendicular to the first cushioning portions 50A and assume a shape standing from portions of the second cushioning portions 50B along the entering surfaces 37 to the front side along a surface direction of the third cushioning portions 50C.

In a state in which the lamp clip 30 is attached to the chassis 22, the first cushioning portions 50A are held between the base part 33 and the bottom surface 22A of the chassis 22 (the reflection sheet 26) and are in contact with the chassis 22. Portions of the second cushioning portions 50B adhered to the locking surfaces 35 are held between the rear surface of the chassis 22 (the rear surfaces of the hole edges of the insertion holes 27) and the locking surfaces 35 and are in contact with the chassis 22. Portions adhered to the entering surfaces 37 are held between the circumferential surfaces of the insertion holes 27 and the entering surfaces 37 and are in contact with the chassis 22. The third cushioning portions 50C are arranged along the circumferential surfaces of the insertion holes 27.

According to the second embodiment configured as explained above, as in the first embodiment, the vibration of the lamp clip 30 is absorbed by the cushions 50. Since it is possible to suppress a creak compared with the case in which the lamp clip 30 and the chassis 22 directly rub against each other, it is possible to prevent deterioration in quality.

### Third Embodiment

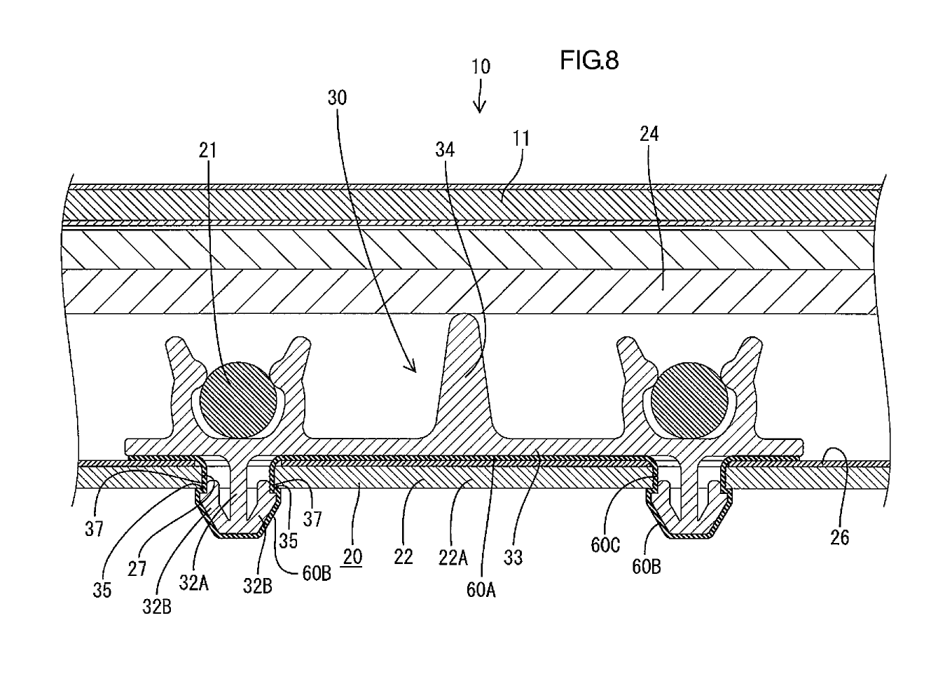

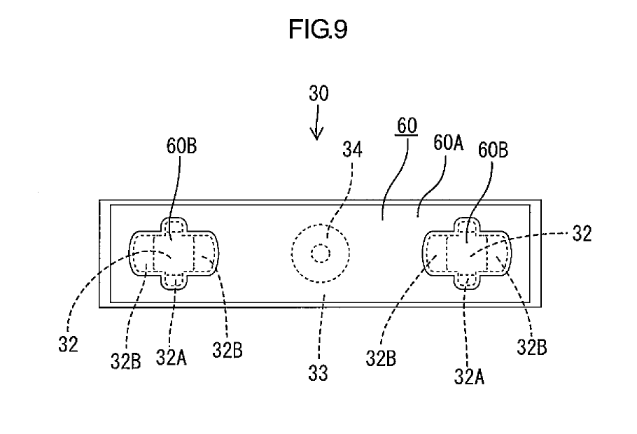

A television receiver TV according to a third embodiment embodying the present invention is explained below with reference to FIGS. 8 and 9.

The television receiver TV according to this embodiment is different from the first embodiment in that cushions 60 integrally include portions arranged between the base part 33 and the chassis 22 and portions arranged between the locking portions 32 and the chassis 22 over the pair of locking portions 32. Components same as those in the first embodiment are denoted by the same reference numerals and signs and redundant explanation of the components is omitted.

The television receiver TV according to this embodiment includes the liquid crystal display device 10 including, as in the first embodiment, the backlight unit 20 and the liquid crystal panel 11 that uses light from this backlight unit 20 for display.

As in the first embodiment, the backlight unit 20 includes the chassis 22 having the discharge tubes 21 arranged on the front side, the diffusing plate 24 arranged in a position opposed to the chassis 22 across the discharge tubes 21, and the lamp clip 30 that has the protruding pin 34 protruding toward the diffusing plate 24 and is attached to the chassis 22 to retain the discharge tubes 21.

As in the first embodiment, the cushions 60 are arranged between the lamp clip 30 and the chassis 22 (the reflection sheet 26). As in the first embodiment, the cushions 60 have thermal conductivity lower than that of the lamp clip 30 and the surfaces of the cushions 50 assume a black color.

The cushions 60 integrally include the portions arranged between the base part 33 and the chassis 22 and the portions arranged between the locking portions 32 and the chassis 22 over the pair of locking portions 32. The cushions 60 assume a sheet shape that covers the substantially entire rear side of the lamp clip 30 all together. As in the first embodiment, the cushions 60 are bonded to the lamp clip 30 by a not-shown adhesive.

In the cushions 60, a first cushioning portion 60A along the rear surface of the base part 33 and second cushioning portions 60B along the outer surfaces of the locking portions 32 are continuously integrally formed.

The first cushioning portion 60A assumes a size for covering substantially the entire rear surface of the base part 33. The outer shape of the first cushioning portion 60A assumes a substantial rectangular shape smaller than the outer shape of the base part 33. Projected portions of the protruding pins 34 on the first cushioning portion 60A are located substantially in the center of the first cushioning portion 60A.

The second cushioning portions 60B are provided at opposite ends of the first cushioning portion 60A. The second cushioning portions 60B are adhered to the outer surfaces of the locking portions 32 (the entire surfaces excluding opposed surfaces of the pair of locking legs 32B and the base portions 32A). Specifically, the second cushioning portions 50B are adhered to surfaces on the opposite side of the entering surfaces 37 of the pair of locking legs 32B, the locking surfaces 35, and the base portions 32A (contact surfaces with the hole edges of the insertion holes 27 during attachment work) and both side surfaces of the locking legs 32B and the base portions 32A (surfaces substantially orthogonal to the opposed surfaces of the locking legs 32B and the base portions 32A).

Portions between the first cushioning portion 60A and the second cushioning portions 60B are respectively third cushioning portions 60C along the circumferential surfaces of the insertion holes 27. The third cushioning portions 60C are substantially perpendicular to the first cushioning portion 60A and assume a shape standing from portions of the second cushioning portions 60B along the entering surfaces 37 to the front side along a surface direction of the third cushioning portions 60C.

In a state in which the lamp clip 30 is attached to the chassis 22, the first cushioning portion 60A is held between the base part 33 and the bottom plate 22A of the chassis 22 (the reflection sheet 26) and is in contact with the chassis 22. Portions of the second cushioning portions 60B adhered to the locking surfaces 35 are held between the rear surface of the chassis 22 (the rear surfaces of the hole edges of the insertion holes 27) and the locking surfaces 35 and are in contact with the chassis 22. Portions adhered to the entering surfaces 37 are held between the circumferential surfaces of the insertion holes 27 and the entering surfaces 37 and are in contact with the chassis 22. The third cushioning portions 60C are arranged along the circumferential surfaces of the insertion holes 27.

According to the third embodiment configured as explained above, as in the first embodiment, the vibration of the lamp clip 30 is absorbed by the cushions 60. Since it is possible to suppress a creak compared with the case in which the lamp clip 30 and the chassis 22 directly rub against each other, it is possible to prevent deterioration in quality.

### Other Embodiments

The present invention is not limited to the embodiments explained by the above description and the drawings. For example, embodiments explained below are also included in the technical scope of the present invention.

(1) In the embodiments, the cushions 40 (50) (60) are made of the black resin. However, the cushions only have to be cushions having surfaces that assume a black color. For example, the cushions may be cushions obtained by coating the outer circumferences of main bodies made of white resin with black resin.

(2) In the embodiments, the cushions 40 (50) (60) are bonded to the lamp clip 30. However, the cushions are not limited to this. The cushions may be bonded to the chassis.

(3) In the embodiments, the cushions 40 (50) (60) are bonded to the lamp clip 30. However, the cushions are not limited to this. The cushions may be bonded to neither the lamp clip nor the chassis and may be held between the lamp clip and the chassis to be retained when the lamp clip is attached.

(4) In the embodiments, the cushions 40 (50) (60) are bonded to the lamp clip 30 by the adhesive. However, the cushions may be bonded to the lamp clip by, for example, a double-sided tape.

(5) In the embodiments, the cushions 40 (50) (60) are bonded to the lamp clip 30 and, when the lamp clips 30 are attached to the chassis 22, the cushions are in contact with the chassis 22. However, an adhesive (a double-sided tape, etc.) may be applied to a contact portion of the cushions with the chassis such that the cushions are bonded to the chassis when the lamp clip is attached to the chassis.

(6) In the first embodiment, the first cushions 40A are provided in each of the locking portions 32. However, the first cushions 40A may be integrally provided.

(7) In the first embodiment, both the first cushions 40A and the second cushions 40B are bonded to the lamp clip 30. However, the cushions are not limited to this. For example, the first cushions may be bonded to the lamp clip and the second cushions may be bonded to the chassis and vice versa.

1. An illumination device comprising:
lamps;
a chassis in which the lamps are arranged;
an optical member arranged in a position opposed to the chassis across the lamps;
lamp clips that are attached to the chassis, retain the lamps, and have protruding pins protruding toward the optical member; and
cushions arranged between the lamp clips and the chassis.

2. The illumination device according to claim 1, wherein
the lamp clips include locking portions locked to an opposite side of the chassis from a side on which the lamps are arranged and base parts, each of the locking portions and each of the base parts holding the chassis therebetween, and
the cushions are arranged at least between the base parts and the chassis.

3. The illumination device according to claim 1, wherein
the lamp clips include locking portions locked to an opposite side of the chassis from a side on which the lamps are arranged, and
the cushions are arranged at least between the locking portions and the chassis.

4. The illumination device according to claim 1, wherein the cushions are formed of a resin material having thermal conductivity lower than that of the lamp clips.

5. The illumination device according to claim 1, wherein the cushions are forms.

6. The illumination device according to claim 1, wherein
the lamp clips include locking portions locked to an opposite side of the chassis from a side on which the lamps are arranged,
insertion holes into which the locking portions are inserted are provided in the chassis, and
the cushions are arranged in positions facing the insertion holes and in a black color.

7. The illumination device according to claim 1, wherein the cushions are bonded to the lamp clips.

8. The illumination device according to claim 1, wherein the cushions are bonded to the chassis.

9. A display device comprising:
the illumination device according to claim 1; and
a display panel configured to provide display using light from the illumination device.

10. The display device according to claim 9, wherein the display panel is a liquid crystal panel including liquid crystals.

11. A television receiver comprising the display device according to claim 9.
